(19) United States
(12) Patent Application Publication
(10) Pub. No.: US 2014/0311648 A1
(43) Pub. Date: Oct. 23, 2014

(54) HEAVY LOAD PNEUMATIC RADIAL TIRE

(71) Applicant: BRIDGESTONE CORPORATION, Chuo-ku (JP)

(72) Inventor: Atsushi Yamada, Kodaira-shi (JP)

(73) Assignee: BRIDGESTONE CORPORATION, Chuo-ku (JP)

(21) Appl. No.: 14/357,883

(22) PCT Filed: Nov. 12, 2012
(86) PCT No.: PCT/JP2012/007235

§ 371 Date: May 13, 2014

(30) Foreign Application Priority Data
Nov. 14, 2011 (JP) 2011-249153

(51) Int. Cl. B60C 9/28

(52) U.S. Cl. CPC B60C 9/28
USPC 152/538

(57) ABSTRACT

A heavy load pneumatic radial tire according to the present invention includes in order, on the radial direction outer side of a carcass extending toroidally between a pair of bead portions, at least one belt reinforcing layer, two or more inclined belt layers, and a tread. When the tire is mounted on a prescribed rim, with prescribed internal pressure applied and in a no-load condition, a width direction edge of the belt reinforcing layer is located further toward the width direction outer side than the tread edge.

### TECHNICAL FIELD

The present invention relates to a heavy load pneumatic radial tire, and in particular to a heavy load pneumatic radial tire with improved wear performance.

### BACKGROUND ART

Conventionally, in heavy load pneumatic radial tires such as tires for trucks and buses, tires for construction vehicles, and the like, a variety of ideas have been adopted to improve wear performance.

In particular, as a way of improving both the wear resistance and resistance to uneven wear of the tire, Patent Literature 1 for example discloses a tire in which a belt reinforcing layer and inclined belt layers are provided in order on the radial direction outer side of the tire carcass.

According to the above structure, first of all the inclined belt layers increase the in-plane shear rigidity of the tread rubber on the surface in the tire circumferential direction and width direction and increase the wear resistance of the tire.

Additionally, the belt reinforcing layer suppresses growth of the tread rubber in the radial direction, making the radial growth amount of the tread rubber uniform in the tire width direction and improving the tire's resistance to uneven wear.

This structure is also useful from the perspective of maintaining tire shape and durability in the face of lower tire aspect ratio and higher weight in recent years.

### CITATION LIST

### Patent Literature

PTL 1: JP2009-184371A

### SUMMARY OF INVENTION

With the tire disclosed in Patent Literature 1, however, the wear resistance and resistance to uneven wear cannot yet be considered sufficient, and there is a demand for a way to further improve these aspects of wear performance, in particular resistance to uneven wear.

The present invention has been conceived in light of the above problem, and it is an object thereof to provide a heavy load pneumatic radial tire with improved resistance to uneven wear.

The inventor intensely studied how to solve the above problem.

As a result, the inventor discovered that uneven wear due to the above tire structure is caused by how the difference in the amount of wear is large between the width direction inner side and width direction outer side of the edge of the belt reinforcing layer.

The inventor also newly discovered that the amount of wear can be made uniform across the entire width direction of the tread by positioning the width direction edge of the belt reinforcing layer further toward a width direction outer side than the tread edge.

Furthermore, the inventor discovered that the above-described in-plane shear rigidity can be further increased and the wear resistance of the tire enhanced by increasing the width in the width direction, over an appropriate range, of at least one layer among the inclined belt layers.

The present invention is based upon the above discoveries, and the main features thereof are as follows.

A heavy load pneumatic radial tire according to the present invention includes in order, on a radial direction outer side of a carcass extending toroidally between a pair of bead portions, at least one belt reinforcing layer, two or more inclined belt layers, and a tread. A width direction edge of the belt reinforcing layer is located further toward a width direction outer side than a tread edge.

According to the present invention, it is possible to provide a heavy load pneumatic radial tire with excellent resistance to uneven wear by optimizing the width in the width direction of the belt reinforcing layer.

According to at least one embodiment of the present invention, it is also possible to improve the tire's wear resistance by optimizing the width in the width direction of the inclined belt layer.

Furthermore, according to at least one embodiment of the present invention, it is possible to maintain the tire's resistance to uneven wear and wear resistance in a high state even after tread wear by optimizing the shape of the tire outer surface.

According to at least one embodiment of the present invention, it is also possible to increase the durability of a heavy load pneumatic radial tire, as demanded in recent years, by setting the minimum distance from the tire outer surface to the belt reinforcing layer and inclined belt layers to be at least a certain distance.

### BRIEF DESCRIPTION OF DRAWINGS

The present invention will be further described below with reference to the accompanying drawings, wherein:

FIG. 1 is a schematic cross-sectional diagram in the width direction of a tire according to an embodiment of the present invention;

FIG. 2 schematically illustrates displacement of the tread edge TE due to progression of wear;

FIG. 3 is a schematic cross-sectional diagram in the width direction of a tire according to Inventive Example 6;

FIG. 4 is a schematic cross-sectional diagram in the width direction of a tire according to Conventional Example 1; and

FIG. 5 is a schematic cross-sectional diagram in the width direction of a tire according to Conventional Example 2.

### DESCRIPTION OF EMBODIMENTS

With reference to the drawings, the following describes a heavy load pneumatic radial tire (referred to below as a tire) according to the present invention in detail.

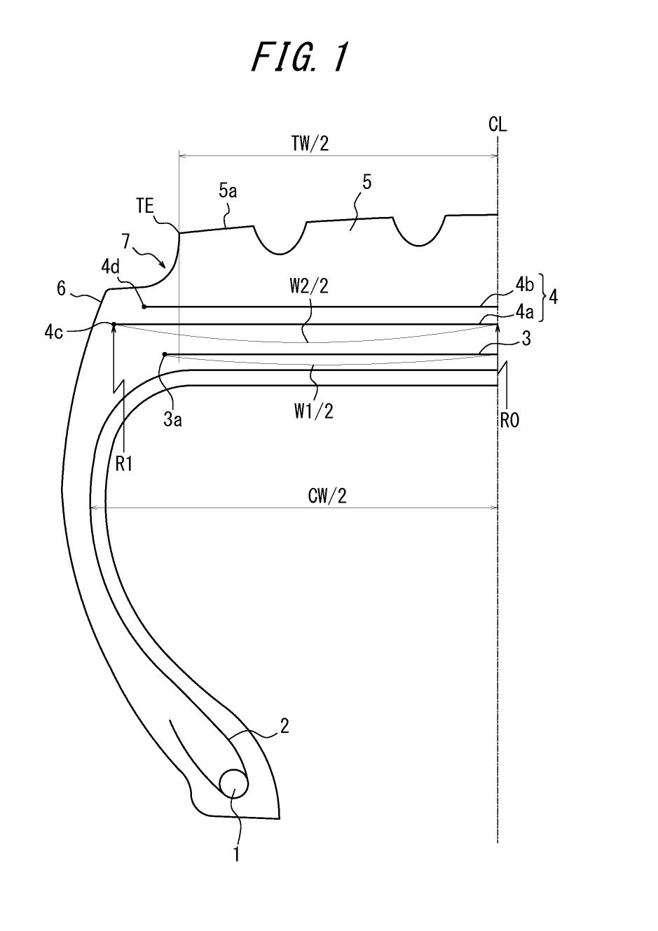

FIG. 1 is a schematic cross-sectional diagram in the width direction of a tire according to an embodiment of the present invention.

FIG. 1 only shows half of the tire, up to the tire equatorial plane CL.

FIG. 1 shows the shape when the tire is mounted on a prescribed rim, with prescribed internal pressure applied, and is in a no-load condition.

As shown in FIG. 1, the tire according to the present invention includes in order, on a radial direction outer side of a carcass 2 extending toroidally between a pair of bead portions (bead core 1 in the illustrated example), at least one belt reinforcing layer 3, two or more inclined belt layers 4, and a tread 5.

In the illustrated example, the belt reinforcing layer 3 is composed of one layer formed by cords that are roughly parallel to the tire circumferential direction and extend at an inclination angle of, for example, 1° to 2°. The belt reinforcing layer 3 may, for example, be formed by spirally winding narrow strips in the circumferential direction.

In the illustrated example, the inclined belt layers 4 are composed of two layers (4a, 4b) extending in the tire circumferential direction at an inclination angle of 40° to 60° and are formed by cords that intersect between layers.

In this disclosure, a “prescribed rim” refers to a rim prescribed by valid industrial standards for the region in which the tire is produced or used, such as the “JATMA (Japan Automobile Tyre Manufacturers Association) Year Book” in Japan, the “ETRTO (European Tyre and Rim Technical Organisation) Standard Manual” in Europe, and the “TRA (Tire and Rim Association, Inc.) Year Book” in the United States of America. Furthermore, “prescribed internal pressure” refers to an air pressure (maximum air pressure) corresponding to the maximum load capability of the tire under the standards of JATMA or the like for a tire of applicable size.

As shown in FIG. 1, when the tire according to the present invention is mounted on a prescribed rim, with prescribed internal pressure applied, and is in a no-load condition, it is crucial that the width direction edge 3a of the belt reinforcing layer 3 be located further toward the width direction outer side than the tread edge TE.

In this way, the effect of suppressing the above-described growth of the tread rubber in the radial direction due to the belt reinforcing layer 3 is achieved across the entire width direction of the tread. Therefore, the amount of wear can be made uniform across the entire width direction of the tread, thereby improving the tire's resistance to uneven wear.

Specifically, the width W1 in the width direction of the belt reinforcing layer 3 is preferably greater than 100% and less than 105% of the tread width TW. The reason is that when the ratio W1/TW exceeds 100%, the amount of wear can be made uniform across the entire width direction of the tread, whereas when the ratio W1/TW is less than 105%, the occurrence of separation at the belt edge due to increased deformation at the belt edge can be suppressed, thereby suppressing a reduction in durability.

The “tread width TW” refers to the distance in the tire width direction between both tread edges TE in a tire width direction cross-section when the tire is mounted on a prescribed rim, with prescribed internal pressure applied and in a no-load condition.

The “maximum width CW of the carcass 2” is defined as the maximum width, in a tire width direction cross-section, of the carcass line that is formed when the tire is mounted on a prescribed rim, with prescribed internal pressure applied and in a no-load condition.

The width W1 in the width direction of the belt reinforcing layer 3 is preferably at least 70% and at most 90% of the maximum width CW of the carcass 2.

The reason is that by setting the ratio W1/CW to be at least 70%, a minimum degree of belt portion hoop effect of the radial tire can be ensured, whereas a ratio W1/CW not exceeding 90% is necessary to achieve a regular radial tire belt width.

In the tire according to the present invention, the width W2 in the width direction of the inclined belt layer, among the inclined belt layers 4, with the largest width in the width direction (belt layer 4a in the illustrated example) is preferably greater than 100% and less than 110% of the tread width TW.

The reason is that by setting the width W2 of the widest inclined belt layer to be greater than 100% of the tread width TW (i.e. setting the ratio W2/TW to exceed 100%), the above-described in-plane shear rigidity of the tread can be increased across the entire width direction of the tread, thereby further increasing the tire's wear resistance.

On the other hand, by setting the width W2 to be less than 110% of the tread width TW (i.e. setting the ratio W2/TW to be less than 110%), the occurrence of separation at the belt edge due to increased deformation at the belt edge can be suppressed, thereby suppressing a reduction in durability.

Furthermore, the width W2 in the width direction of the widest inclined belt layer 4a is preferably larger than the width W1 in the width direction of the belt reinforcing layer 3.

The reason is that by setting the width W2 to be larger than the width W1, deformation of the width direction edge of the belt reinforcing layer 3 can be effectively suppressed.

Note that when the width W2 is made larger than the width W1, cushion rubber is preferably provided in order to ensure the initial shape of the product tire by preventing the edge 4c of the inclined belt layer 4a from dropping toward the radial direction inner side.

This cushion rubber is preferably provided in a region toward the radial direction inner side from the edge 4c of the inclined belt layer 4a and adjacent to the edge 3a of the belt reinforcing layer.

When the tire is mounted on a prescribed rim, with prescribed internal pressure applied, and is in a no-load condition, R0 is defined as the curvature radius, at a position of intersection with the tire equatorial plane CL, of the belt layer 4a having the greatest width in the width direction within the inclined belt 4, and R1 is defined as the curvature radius of the belt layer 4a at the edge 4c. With these definitions, the tire according to the present invention preferably satisfies the following expression.

2(R0−R1)/W2≦0.06

The reason for reducing the radius difference in the tire width direction to be in the above range is that the circumferential shear deformation of interlayer rubber between the inclined belt layers and the belt reinforcing layer, in particular between the edges of the inclined belt layers and the edges of the belt reinforcing layer, can be suppressed. Therefore, belt separation occurring between an adjacent inclined belt layer and belt reinforcing layer can be suppressed, ensuring the durability of the tire.

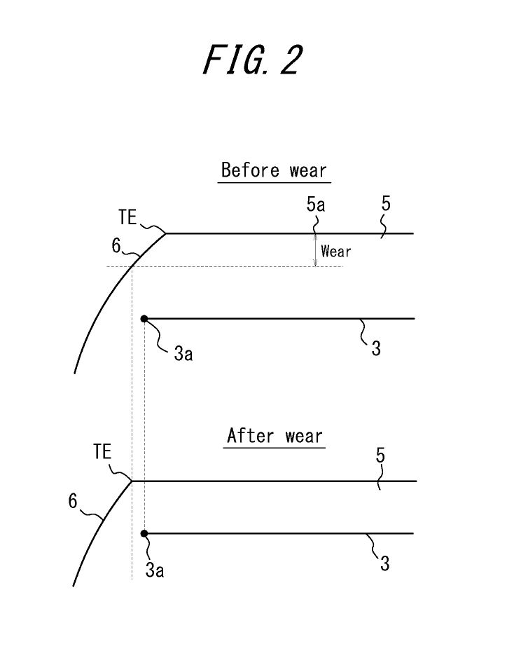

As illustrated schematically in FIG. 2, a region of approximately 5 mm to 20 mm towards the radial direction inner side from the tire tread surface 5a is a region in which tread rubber becomes worn as the tire is used.

Accordingly, the tread edge TE is displaced toward the width direction outer side as the tread rubber becomes worn.

Therefore, as wear progresses in the tread rubber, the edge 3a of the belt reinforcing layer 3 may become located further on the width direction inner side than the tread edge TE, preventing the above-described effect of suppressing wear and uneven wear from being achieved.

In FIG. 2, the belt reinforcing layer 3 is illustrated as an example, yet the same is true for the relationship between the tread edge TE and the edges 4c and 4d of the belt layer 4.

Therefore, in the present invention, as illustrated in FIG. 1, the tire outer surface 6 preferably has an annular recess 7 curving convexly towards the tire width direction inner side in a range of approximately 5 mm to 35 mm further toward the tire radial direction inner side than the tread edge TE.

In this way, even if tread wear progresses, displacement of the tread edge TE toward the width direction outer side nearly stops. Accordingly, even if tread wear progresses, the edge 3a of the belt reinforcing layer and the edges 4c and 4d of the belt layer 4 can be positioned further toward the width direction outer side than the tread edge TE. Hence, even after progression of tread wear, the effects of improving the wear resistance and the resistance to uneven wear can be achieved.

Note that by making the shape, in a width direction cross-section, of the recess 7 be deeply convex in the width direction, the above effects can be achieved to a higher degree.

Further toward the tire radial direction inner side than the tread edge TE, the shortest distance d (mm) from the tire outer surface 6 to the belt reinforcing layer 3 and inclined belt layers 4a and 4b is preferably 10 mm or more.

The reason is that by ensuring an interval of at least 10 mm between the tire outer surface 6 and each of the reinforcing members, i.e. the belt reinforcing layer 3 and the inclined belt layers 4a and 4b, the occurrence of cracks at the belt edge can be prevented, thereby improving the durability of the tire.

The interval in the radial direction between the thickness center position of cords constituting the belt reinforcing layer 3 and the thickness center position of cords constituting the belt layer 4a adjacent to the belt reinforcing layer 3 is preferably 1.8 to 7.0 times the diameter of the cords constituting the belt reinforcing layer 3.

The reason is that by ensuring a sufficient interval of 1.8 times or more, the circumferential shear deformation, which concentrates at the edge 3a of the belt reinforcing layer 3 and the edge 4c of the belt layer 4a, can be effectively reduced by the rubber between the belt reinforcing layer 3 and the belt layer 4a, thereby preventing breakage of the rubber between the belt reinforcing layer 3 and the belt layer 4a due to the circumferential shear deformation.

Furthermore, by setting the interval to be at most 7.0 times the above cord diameter, when the belt reinforcing layer 3 is provided at an appropriate position, the position of the outermost reinforcing layer 4b can be prevented from being too far to the radial direction outer side, thereby preventing early exposure of the outermost reinforcing layer 4b due to wear. On the other hand, when the outermost belt layer 4b is provided at an appropriate position, the position of the belt reinforcing layer 3 can be prevented from being too far to the radial direction inner side, an excessive increase in the radial direction growth at the belt reinforcing layer edge can be suppressed when internal pressure is applied, and separation of rubber at the edges can be suppressed. In other words, in either case, the durability of the tire can be ensured.

### EXAMPLES

In order to confirm the effects of the present invention, tires according to Inventive Examples 1 to 17 were produced, and tires according to Conventional Examples 1 and 2 were also prepared. Tire performance was then evaluated by experiment.

Table 1 lists the specifications for each tire.

In Table 1, TW represents the tread width, W1 represents the width in the width direction of the belt reinforcing layer, and W2 represents the width in the width direction of the inclined belt, within the inclined belt layer, having the largest width in the width direction.

Furthermore, in Table 1, R0 represents the curvature radius, at a position of intersection with the tire equatorial plane, of the widest inclined belt layer, and R1 represents the curvature radius at the belt edge of the widest inclined belt layer.

Furthermore, d (mm) represents the shortest distance from the tire outer surface to the belt reinforcing layer and inclined belt layers.

Also, “includes recess” means that in a radial direction, in a range of 5 mm to 35 mm further toward the radial direction inner side than the tread edge TE, the tire outer surface has a recess curving convexly towards a tire width direction inner side.

Note that these shapes are defined when the tire is mounted on a prescribed rim, with prescribed internal pressure applied, and is in a no-load condition.

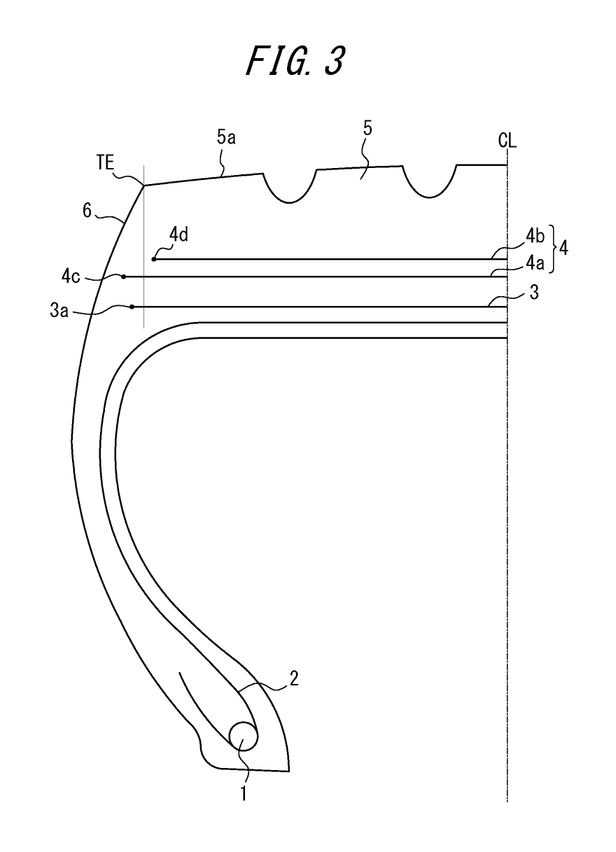

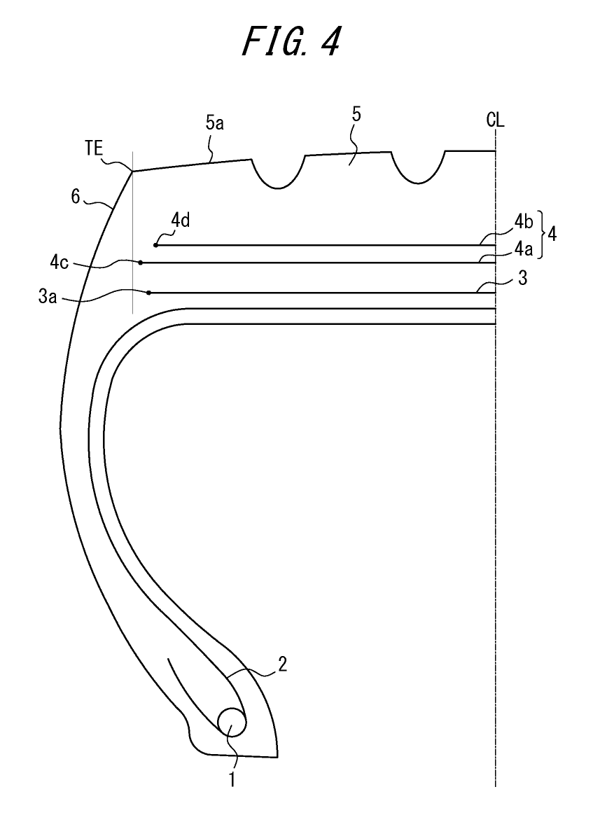

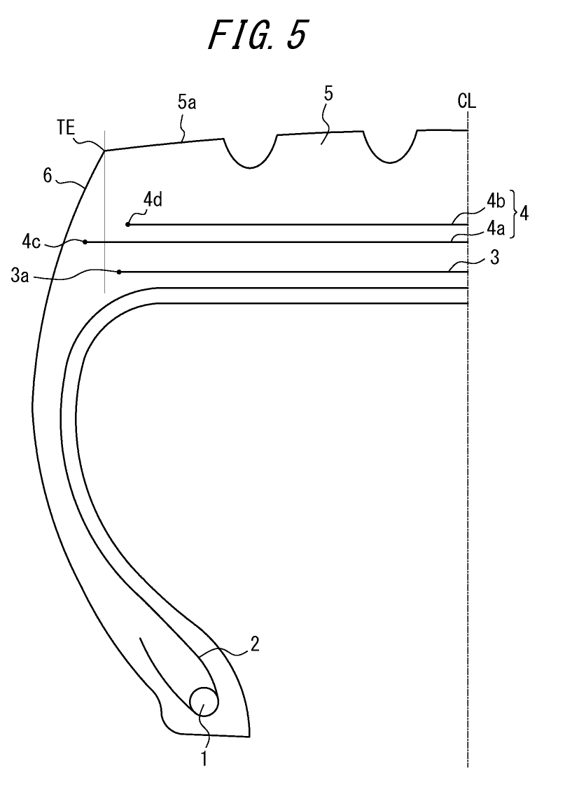

TABLE 1

| | FIG. | W1/TW (%) | W2/TW (%) | 2(R0 − R1)/W2 | d (mm) | Tire outer suface |
|---|---|---|---|---|---|---|
| Inventive | FIG. 1 | 101 | 97 | 0.04 | 12 | Includes recess |
| Example 1 | | | | | | |
| Inventive | FIG. 1 | 101 | 106 | 0.07 | 12 | Includes recess |
| Example 2 | | | | | | |
| Inventive | FIG. 1 | 101 | 106 | 0.06 | 12 | Includes recess |
| Example 3 | | | | | | |
| Inventive | FIG. 1 | 101 | 106 | 0.04 | 12 | Includes recess |
| Example 4 | | | | | | |
| Inventive | FIG. 1 | 101 | 106 | 0.09 | 12 | Includes recess |
| Example 5 | | | | | | |
| Inventive | FIG. 3 | 101 | 106 | 0.04 | 12 | Does not include |
| Example 6 | | | | | | recess |
| Inventive | FIG. 1 | 101 | 106 | 0.04 | 7 | Includes recess |
| Example 7 | | | | | | |
| Inventive | FIG. 1 | 101 | 109 | 0.07 | 12 | Includes recess |
| Example 8 | | | | | | |
| Inventive | FIG. 1 | 101 | 113 | 0.07 | 12 | Includes recess |
| Example 9 | | | | | | |
| Inventive | FIG. 1 | 105 | 106 | 0.07 | 12 | Includes recess |
| Example 10 | | | | | | |
| Inventive | FIG. 1 | 105 | 106 | 0.06 | 12 | Includes recess |
| Example 11 | | | | | | |
| Inventive | FIG. 1 | 105 | 109 | 0.05 | 12 | Includes recess |
| Example 12 | | | | | | |
| Inventive | FIG. 1 | 105 | 113 | 0.05 | 12 | Includes recess |
| Example 13 | | | | | | |
| Inventive | FIG. 1 | 107 | 106 | 0.08 | 12 | Includes recess |
| Example 14 | | | | | | |
| Inventive | FIG. 1 | 107 | 106 | 0.06 | 12 | Includes recess |
| Example 15 | | | | | | |
| Inventive | FIG. 1 | 107 | 109 | 0.02 | 12 | Includes recess |
| Example 16 | | | | | | |
| Inventive | FIG. 1 | 107 | 113 | 0.02 | 12 | Includes recess |
| Example 17 | | | | | | |
| Conventional | FIG. 4 | 77 | 97 | 0.09 | — | Does not include |
| Example 1 | | | | | | recess |
| Conventional | FIG. 5 | 86 | 102 | 0.07 | — | Does not include |
| Example 2 | | | | | | recess |

The assessments were performed as follows.

### Wear Performance

Each of the above tires with a tire size of 445/50R22.5 was mounted on a prescribed rim, internal pressure of 690 kPa was applied, and a load of 38 kN per tire was applied. The amount of wear in the tread rubber was measured after driving 30,000 km at a speed of 60 km/h.

Measurements were performed at three measurement locations: a tread width direction central position, and positions A and B respectively at 80% and 98% of the tread width towards the width direction inner side from the tread edge.

In Table 2, the wear resistance is assessed as an index for the amount of wear at the tread width direction central position, with the amount of wear for Conventional Example 1 as 100.

The index is smaller for a smaller amount of wear, indicating better wear resistance.

In Table 2, the resistance to uneven wear for each tire is indicated by an index for the amount of wear at positions A and B, with the amount of wear at the tread width direction central position as 100.

A value closer to 100 for these indices indicates better resistance to uneven wear.

Furthermore, in order to evaluate the wear performance after progression of wear, the same evaluation test of wear resistance and resistance to uneven wear as above was performed for the tires according to Inventive Example 4 and Inventive Example 6 after 10 mm of the tread had worn away. Table 3 lists the evaluation results for wear performance after progression of wear.

### Durability

The tires according to Inventive Examples 1 to 17 and Conventional Examples 1 and 2 were mounted on a prescribed rim, and a high-speed durability drum test was performed under the conditions of an internal pressure of 690 kPa and a load of 38 kN. Under the above conditions, starting at a speed of 120 km/h in the drum, the speed was raised by 10 km/h every 30 minutes, and the time until tire failure was measured. Evaluation was made based on the measurement value. Table 2 lists the evaluation results.

In Table 2, the results are indicated as an index with the speed at which failure occurred for Inventive Example 1 as 100. A larger index indicates better durability.

TABLE 2

| | Amount of | | | |
|---|---|---|---|---|
| | wear at tread | Amount of | Amount of | |
| | width direction | wear at | wear at | |
| | central position | position A | position B | Durability |
| Inventive | 78 | 102 | 105 | 100 |
| Example 1 | | | | |
| Inventive | 78 | 103 | 106 | 94 |
| Example 2 | | | | |
| Inventive | 77 | 102 | 105 | 98 |
| Example 3 | | | | |
| Inventive | 75 | 101 | 104 | 100 |
| Example 4 | | | | |
| Inventive | 80 | 104 | 114 | 90 |
| Example 5 | | | | |
| Inventive | 76 | 103 | 110 | 100 |
| Example 6 | | | | |
| Inventive | 76 | 100 | 103 | 87 |
| Example 7 | | | | |
| Inventive | 75 | 102 | 104 | 92 |
| Example 8 | | | | |
| Inventive | 74 | 102 | 103 | 88 |
| Example 9 | | | | |
| Inventive | 75 | 101 | 104 | 90 |
| Example 10 | | | | |
| Inventive | 75 | 101 | 103 | 97 |
| Example 11 | | | | |
| Inventive | 75 | 101 | 102 | 96 |
| Example 12 | | | | |
| Inventive | 74 | 101 | 102 | 93 |
| Example 13 | | | | |
| Inventive | 77 | 103 | 111 | 85 |
| Example 14 | | | | |
| Inventive | 76 | 102 | 104 | 95 |
| Example 15 | | | | |
| Inventive | 75 | 101 | 105 | 94 |
| Example 16 | | | | |
| Inventive | 73 | 100 | 104 | 95 |
| Example 17 | | | | |
| Conventional | 100 | 106 | 143 | 100 |
| Example 1 | | | | |
| Conventional | 94 | 102 | 127 | 100 |
| Example 2 | | | | |

TABLE 3

| | Amount of | | |
|---|---|---|---|
| After | wear at tread | Amount of | Amount of |
| progression | width direction | wear at | wear at |
| of wear | central position | position A | position B |
| Inventive | 100 | 104 | 107 |
| Example 4 | | | |
| Inventive | 105 | 109 | 115 |
| Example 6 | | | |

As Table 2 shows, all of the tires according to Inventive Examples 1 to 17 had improved wear resistance as compared to the tires according to Conventional Examples 1 and 2, with a reduced amount of wear in the tread width central portion. Furthermore, all of the tires according to Inventive Examples 1 to 17 had improved resistance to uneven wear as compared to the tires according to Conventional Examples 1 and 2, with a lesser difference between the amount of wear at position A and the amount of wear at position B.

Table 2 also shows that Inventive Example 4, in which the width in the width direction of the widest inclined belt layer was optimized, had better tire wear resistance than Inventive Example 1.

Furthermore, a comparison of Inventive Example 4 and Inventive Example 6 in Table 3 shows that Inventive Example 4, provided with a recess at an appropriate position on the tire outer surface, had both excellent wear resistance and resistance to uneven wear of the tire even after progression of wear.

A comparison of Inventive Example 2 and Inventive Example 3 in Table 2 also shows that Inventive Example 3, in which the shape of the widest inclined belt layer was optimized, had excellent tire durability as compared to Inventive Example 2. A comparison of Inventive Example 4 and Inventive Example 7 shows that Inventive Example 4, in which the above shortest distance d (mm) was optimized, had better durability than the tire according to Inventive Example 7.

### REFERENCE SIGNS LIST

1: Bead core

2: Carcass

3: Belt reinforcing layer

4: Inclined belt layer

5: Tread

6: Tire outer surface

7: Recess

1. A heavy load pneumatic radial tire comprising in order, on a radial direction outer side of a carcass extending toroidally between a pair of bead portions, at least one belt reinforcing layer, two or more inclined belt layers, and a tread, wherein
when the tire is mounted on a prescribed rim, with prescribed internal pressure applied and in a no-load condition, a width direction edge of the belt reinforcing layer is located further toward a width direction outer side than a tread edge;
wherein further toward a radial direction inner side than the tread edge, a tire outer surface includes a recess curving convexly towards a width direction inner side;
wherein the width edge of the belt reinforcing layer is located further toward a width direction outer side than a tread edge when a predetermined amount of the tread has worn away.

2. The heavy load pneumatic radial tire according to claim 1, wherein a width W1 in the width direction of the belt reinforcing layer is greater than 100% and less than 105% of a tread width TW.

3. The heavy load pneumatic radial tire according to claim 1, wherein a width W2 in the width direction of an inclined belt layer, among the inclined belt layers, having a largest width in the width direction is greater than 100% and less than 110% of a tread width TW.

4. The heavy load pneumatic radial tire according to claim 1, satisfying the expression
2×(R0−R1)/W2≦0.06
where R0 is a curvature radius, at an intersection with a tire equatorial plane, of the inclined belt layer having the largest width, and R1 is a curvature radius of the inclined belt layer having the largest width at a belt edge thereof.

5. The heavy load pneumatic radial tire according to any one of claim 1, wherein further toward a radial direction inner side than the tread edge, a tire outer surface includes a recess curving convexly towards a width direction inner side.

6. The heavy load pneumatic radial tire according to any one of claim 1, wherein further toward a radial direction inner side than the tread edge, a shortest distance from a tire outer surface to the belt reinforcing layer and the inclined belt layers is 10 mm or more.

7. The heavy load pneumatic radial tire according to claim 1, wherein the predetermined amount of tread that has worn away is 10 mm.
